(19) United States
(12) Patent Application Publication
(10) Pub. No.: US 2007/0196724 A1
(43) Pub. Date: Aug. 23, 2007

(54) Aqueous electrolyte mixture for mcfcs

(75) Inventors: Annalisa Sabattini, Genova (IT); Elena Bergaglio, Novi Ligure (IT)

Correspondence Address: SHOEMAKER AND MATTARE, LTD, 10 POST OFFICE ROAD - SUITE 110, SILVER SPRING, MD, 20910, US

(73) Assignee: ANSALDO FUEL CELLS S.P.A., Genova (IT)

(21) Appl. No.: 10/599,581

(22) PCT Filed: Mar. 31, 2004
(86) PCT No.: PCT/IT04/00164

§ 371 Date: Nov. 8, 2006

(51) Int. Cl. H01M 8/14; C23G 5/00

(52) U.S. Cl. 429/46; 252/364

(57) ABSTRACT

The present invention relates to an electrolytic mixture for molten carbonate fuel cells (MCFCs). The carrier solution is constituted by one or more organic solvents and water, with an organic solvent percentage comprised of between 5% and 80%. The electrolyte consists of a mixture of Li₂CO₃ and LiKCO₃ in such stoichiometric ratios as to give the Li₂CO₃/K₂CO₃ 62/38 eutectic mixture. The compound LiKCO₃ has a solubility in water, like lithium carbonate, less than that of the potassium carbonate, which is normally found in MCFC electrolytic mixtures. This allows the resolution of the problem of electrolyte loss during the operation of the cell, due to the solubilisation of the same in water.

### FIELD OF THE INVENTION

The present invention relates to an electrolytic mixture to be used in molten carbonate fuel cells.

### BACKGROUND ART

Fuel cells are systems which allow the conversion of the chemical energy of a fuel into electrical energy through an electrochemical oxidation reaction of the fuel, without any intermediate transformations into thermal and mechanical energy. Hence, they are capable of higher conversion yields with respect to those of traditional thermal machines.

Oxidation of the fuel is obtained as the sum of two complimentary half-reactions, occurring simultaneously in contiguous environments, physically separated by a gas tight membrane.

In molten carbonate fuel cells (MCFCs) the membrane, known as the matrix, is a thin sheet of LiAlO₂, having a thickness between 0.5 and 1.5 mm, containing the electrolyte from which the ions, which one half-reaction consumes and the other produces, are derived. In this case, the electrolyte is a solution of molten alkaline carbonates at the operating temperature of the cell (approx. 650° C.).

For correct functioning of the system, it is necessary that the matrix be completely filled with electrolyte so that it may operate as a barrier and may allow the transportation of the carbonate ions. Furthermore, in order to have good performance, it is indispensable that the electrodes are optimally wetted with electrolyte in order to keep the carbonate-gas-catalytic sites in constant contact, thus allowing the reactions to proceed. It is therefore necessary to ensure the correct amounts, the exact positioning of the electrolyte within the cell and also a certain amount of reserve, in order to make up for any inevitable consumption of the carbonates due to corrosion, evaporation and migration phenomena of the molten salts within the stack (the stack is a collection of cells arranged in series).

All these problems have been dealt with, over the years, in different manners.

A proposal for providing the appropriate amount of electrolyte is cited in the patent EP 0 509 424: the production of a sheet of matrix is proposed with lithium aluminate particles mixed with carbonate powders and binders to be inserted between the electrodes. With the increase in temperature during the start up of the stack, the carbonates may melt in situ within the matrix and occupy the pores liberated by the binders which have decomposed in the meantime.

There are, however, some limitations: the carbonate particles, by excessively distancing those of the lithium aluminate, give rise to the presence of pores which are too large for a matrix which must be able to retain the carbonates by capillary action. This causes bad functioning of the matrix and, hence, of the cell.

In order to stem the problem of electrolyte consumption, in the patent U.S. Pat. No. 4,980,248, the introduction of a layer of an oxide composite containing lithium, in the area with atmospheric air, has been proposed. In the case of any variation in the Li/K ratio, the compound would react with atmospheric CO₂, liberating lithium carbonate and thus restoring the desired amount. A further idea is reported in the patent U.S. Pat. No. 4,538,348 wherein impregnation of the anode is foreseen, achieved by placing powdered carbonates on the porous anode and subjecting it to a thermal treatment, reaching the melting temperature of the salts so that these, once transformed into liquid form, may penetrate into the pores.

This however, refers to a system which is only effective in the case of electrodes having considerable thickness since, in the opposite case, these would not have the necessary capacity for holding a sufficient quantity of carbonates for the prolonged operation of the stack.

The current line for the resolution of the above mentioned problems, has been described for the first time in the patent U.S. Pat. No. 5,468,573 and provides for the loading of the electrolyte in the form of a “paste” onto the current collectors, so that with the increasing temperature the carbonates melt and penetrate into the matrix and into the electrodes. This system allows having a certain amount of reserve electrolyte available. This paste is obtained by mixing the carbonate powders with an organic carrier solution, for example waxes, vaseline, glycerine etc., in order to obtain a mixture of such consistency and viscosity as to be able to be spread over the current collectors without spilling out sideways during the assembly of the stack or of the cell itself. For example, glycerine functions solely as a carrier without creating any problems during the delicate melting stage since, with heating, it is removed at around 300° C., without leaving any dangerous residues. A eutectic mixture of Li₂CO₃/K₂CO₃, in a ratio of 62/38, is used as an electrolyte. A variant of the patent U.S. Pat. No. 5,468,573 is described in patent WO 03/073544 wherein water is used as the carrier solution. A slurry of carbonates in water is prepared in a mixer and is spread within the channels of the bipolar separator plates; a controlled air drying process is then performed, in order to avoid the solubilisation of the K₂CO₃. It is only possible to assemble the cell when the carbonate mixture is thoroughly dry. The solutions proposed in the last patents cited, U.S. Pat. No. 5,468,573 and WO 03/073544, both have some drawbacks. The present invention allows overcoming the drawbacks which are observed in the processes described in the aforesaid patents; particularly those deriving from the use of water or an organic substance as a carrier solution for the preparation of the electrolytic paste. For example, relating to the use of glycerine as a carrier for the carbonates, it has been observed that a minimum temperature of around 80° C. is necessary in order to obtain electrolytic paste which is easily applicable to the surface of the current collectors. This makes it necessary, for industrial production, to have a mixer made in such a way that each of its parts involved with the passage of the mixture be maintained at a constant temperature of 80° C., with a consequent increase in costs related to the additional insulation.

Still, in order to maintain the proper fluidity of the mixture, it is also necessary to heat the current collectors, since any sudden cooling from 80° C. to room temperature would tend to make the electrolytic paste solidify, thus making the distribution of the carbonates inhomogeneous. Furthermore, the working risk associated with having to constantly manage high temperature materials is to be considered.

In relation to the use of water as a solvent for the preparation of the electrolyte slurry, it is underlined that if there is any K₂CO₃ present in the Li₂CO₃/K₂CO₃ eutectic mixture, then the possibility that this solubilises upon contact with water is greater. Hence, in order to avoid the transport of the K₂CO₃, it is necessary to immediately dry the carbonates mixture after this has been spread over the bipolar separator plates. Consequently, by working with water, a non-dangerous and non-flammable solvent, a stage is however added to the assembly process of the cell.

### SUMMARY OF THE INVENTION

The present invention refers to an electrolytic mixture for molten carbonate fuel cells comprising a carrier solution, constituted by a mixture of one or more organic solvents and water, and a carbonates mixture in such stoichiometric ratios as to obtain the Li₂CO₃/K₂CO₃ eutectic mixture in a ratio of 62/38.

Preferably, said carbonates mixture is constituted by Li₂CO₃ and LiKCO₃ and said carrier solution is a mixture of water and one or more organic solvents selected from: vaseline, wax or glycerine. Still more preferably, said carrier solution is a mixture of glycerine and water with a percentage of glycerine preferably comprised of between 5% and 80% by weight, more preferably between 15% and 50% by weight.

Therefore, within the electrolyte mixture of the present invention, water soluble K₂CO₃ is absent, whilst LiKCO₃, which has greatly reduced solubility in water, is present. This allows the attainment of a homogeneous electrolytic mixture, overcoming the problems described in the state of the art.

The present invention also provides further advantages such as:

the possibility of working at temperatures of less than 40° C. thus eliminating all the previously described difficulties;

the stage of immediately drying the electrolytic mixture, following its spreading over the current collector, carried out so as to prevent solubilisation of the K₂CO₃, is eliminated;

an electrolytic mixture is obtained in the form of a paste and not a powder, even following the evaporation of the water from the paste spread over the collector.

### DETAILED DESCRIPTION OF THE INVENTION

The electrolytic mixture for MCFC is prepared by mixing the carrier solution with a mixture of carbonates. The carrier solution is a mixture of water and an organic solvent, for example vaseline, wax and/or glycerine, in quantities comprised of between 5% and 80% by weight, preferably between 15% and 50% by weight. Preferably, the organic solvent will be glycerine.

The carbonates mixture consists of Li₂CO₃ and a LiKCO₃ congruent melting compound. Such mixture is obtained by mixing in a ball mill, for a period of time comprised of between 10 and 48 hours, preferably 20-28 hours, the Li₂CO₃ and K₂CO₃ salts in such stoichiometric ratios as to obtain, by mechanically working, the eutectic mixture Li₂CO₃/K₂CO₃ 62/38 wherein Li₂CO₃ and the LiKCO₃ congruent melting compound are present in a ratio of 1:3. Preferably, Li₂CO₃ and K₂CO₃ will be mixed in a stoichiometric ratio comprised of between 3:1 and 1:1, preferably in a ratio of 1.7:1.

The carbonates are present within the electrolytic mixture in quantities comprised of between 50% and 90%, preferably 70% and 80%. Therefore, an electrolytic paste is obtained, which is spread over the current collector at room temperature.

### EXAMPLE

The glycerine and water, in 1:1 proportions, are mixed in a beaker. 46 grams of Li₂CO₃ and 54 grams of K₂CO₃, a stoichiometric ratio of 1.7:1, are weighed out separately, and are mixed in a ball mill for 24 hours so as to obtain the Li₂CO₃/K₂CO₃ 62/38 eutectic carbonates mixture composed of Li₂CO₃ and LiKCO₃ in a ratio of 1:3.

Having obtained the Li₂CO₃/K₂CO₃ 62/38 eutectic mixture, the electrolytic paste is obtained by mixing the carbonates mixture with the carrier solution in the ratio of 70:30.

70 grams of carbonates mixture is added to 30 grams of carrier solution. The addition is carried out gradually by continuously mixing the paste which is being formed.

At this point, the electrolytic paste thus formed, is homogeneously spread over the current collector, using a spatula at 25° C., so as to make the carbonates mixture penetrate into all the channels of the collector. At the end of the operation, the collector is turned over and the electrode is placed onto the surface not covered by electrolytic paste.

Physico-Chemical Tests

In order to evaluate any possible modifications introduced into the electrolyte by mixing the carbonate powders with the glycerine/water solution in place of glycerine alone, thermal tests (with a differential scanning calorimeter) and X-ray tests have been performed. Particularly, an electrolytic mixture has been tested in a glycerine/water 80/20 solution and, for comparison, in a solution of glycerine alone and of water alone.

The results have demonstrated that the new solution does not alter the melting point of the eutectic carbonates mixture, maintaining the temperature at which the phase transformation occurs between 490 and 500° C. In FIG. 1 the comparison between the calorimetry curve of the pure eutectic carbonates mixture and that of the carbonates mixed with glycerine alone and with glycerine and water in the ratio 80/20 is reported. The tests have been carried out in 80 ml/min nitrogen flow with a heating ramp rate of 10° C./min. It is observed that the carbonates/glycerine and carbonates/glycerine/water mixtures have more broadened melting peaks with respect to the pure carbonates mixture but, however, the phase transformation occurs within the desired temperature range (489° C., 495° C. and 498° C.) In FIG. 2 the calorimetric curve of the pure eutectic mixture is compared with those obtained from the carbonates/water mixture. All the tests have been carried out in 80 ml/min nitrogen flow with a heating ramp rate of 10° C./min.

FIGS. 3-6 show the X-ray tests of the pure eutectic mixture, with glycerine, glycerine/water and water carriers. As may be observed, the eutectic mixture does not undergo any alterations.

Hence, it is possible to conclude that the undesired effect of the solubilisation of the carbonates in water, particularly the potassium carbonate, does not occur. This is due to the composition of the starting powders: The Li₂CO₃/K₂CO₃ 62/38 eutectic mixture is constituted by LiKCO₃ and Li₂CO₃ compounds in a ratio of 3:1 without the presence of any free potassium carbonate, as it is possible to observe from the X-ray tests (FIG. 3). The experimental result agrees with the state diagram of the mixture of the two Li₂CO₃ and K₂CO₃ salts.

Tests carried out in a monocell, by mixing the carbonates with the glycerine/water solution, in order to monitor any possible effects during operation, have observed performances entirely comparable with cells wherein glycerine is used alone as carrier, without detecting any particular effects during start-up and above all at the carbonates melting point.

1-21. (canceled)

22. An electrolytic mixture for molten carbonate fuel cells comprising a carrier solution and a carbonates mixture, wherein said carrier solution is a mixture of one or more organic solvents and water.

23. The electrolytic mixture according to claim 22 wherein said carbonates are mixed in such stoichiometric ratios as to obtain the Li₂CO₃/K₂CO₃ eutectic mixture in a ratio of 62/38.

24. The electrolytic mixture according to claim 22 wherein Li₂CO₃ and K₂CO₃ are mixed in a stoichiometric ratio of between 3:1 and 1:1.

25. The electrolytic mixture according to claim 24, wherein said ratio is 1.7:1.

26. The electrolytic mixture according to claim 22 wherein said carbonates mixture consists essentially of Li₂CO₃ and LiKCO₃.

27. The electrolytic mixture according to claim 26 wherein LiKCO₃ and Li₂CO₃ are present in a stoichiometric ratio of 3:1.

28. The electrolytic mixture according claim 22 wherein said one or more organic solvents are selected from the group consisting of vaseline, wax and glycerine.

29. The electrolytic mixture according claim 22 wherein said carrier solution is a mixture of glycerine and water, with a glycerine content between 5% and 80% by weight.

30. The electrolytic mixture according to claim 29, wherein said carrier solution is a glycerine and water mixture with a glycerine content between 15% and 50% by weight.

31. The electrolytic mixture according to claim 22 wherein said carbonates are present in quantities of between 50% and 90% by weight.

32. The electrolytic mixture according to claim 31 wherein said carbonates are present in quantities of between 70% and 80% by weight.

33. The electrolytic mixture according to claim 22 in the form of a spreadable paste.

34. A process for producing the electrolytic mixture according to claim 22, said process comprising steps of:
a) mixing one or more organic solvents and water;
b) separately mixing the carbonates; and then
c) mixing the carrier solution obtained in step a) with the carbonates mixture obtained in step b).

35. The process according to claim 34 wherein, in step a), said one or more solvents are selected from the group consisting of vaseline, wax and glycerine, and comprise between 5% and 80% by weight of the mixture.

36. The process according to claim 35, wherein said solvent is glycerine.

37. The process according to claim 35, wherein said solvents comprises between 15% and 50% by weight of the mixture.

38. The process according to claim 34 wherein, in step b), the carbonates used are preferably Li₂CO₃ and K₂CO₃ mixed in a stoichiometric ratio between 3:1 and 1:1.

39. The process according to claim 38, wherein said stoichiometric ratio is 1.7:1.

40. The process according to claim 34 wherein, in step b), the carbonates are mixed in a ball mill for between 10 and 48 hours.

41. The process according to claim 40, wherein said period of time is between 20 and 28 hours.

42. The process according to claim 34 wherein, in step c), the carbonates are mixed with the carrier solution in quantities of between 50% and 90%

43. The process according to claim 42, wherein said carrier solution quantities are between 70% and 80%.

44. The process according to claim 34 wherein step c) involves the gradual addition of the carbonates mixture into the carrier solution with constant mixing.

45. A current collector comprising a layer of electrolytic mixture, according to claim 22, spread over at least one of its surfaces.

46. A molten carbonate fuel cell comprising a current collector according to claim 45.

47. A collector preparation method comprising steps of:
a) spreading an electrolytic mixture over at least one surface of a current collector; and;
b) placing said collector on the electrode using a surface not covered by said electrolytic mixture.

48. The method according to claim 47 wherein step a) takes place at room temperature.
